(19) United States
(12) Patent Application Publication
(10) Pub. No.: US 2024/0075673 A1
(43) Pub. Date: Mar. 7, 2024

(54) GRAVITY RAIL SYSTEM AND METHOD FOR TRANSFERRING WIDE-MOUTH PREFORMS

(71) Applicant: GRAHAM PACKAGING COMPANY, L.P., Lancaster, PA (US)

(72) Inventors: Rachel Dahlberg, Boston, MA (US); Ian McDougal, Windsor, CO (US); Christopher Rhodus, Berea, KY (US); Derek Borigo, Elkins Park, PA (US); Randy Kincel, Mechanicsburg, PA (US); Freddy Tackett, Staffordsville, KY (US); Eric Lawson, Louisville, KY (US)

(21) Appl. No.: 18/242,610

(22) Filed: Sep. 6, 2023

Related U.S. Application Data
(60) Provisional application No. 63/404,390, filed on Sep. 7, 2022.

(51) Int. Cl. B29C 49/42

(52) U.S. Cl. CPC B29C 49/42097; B29C 49/42065; B29C 2949/0771

(57) ABSTRACT

A gravity rail system for transferring wide-mouth preforms comprising a first rail configured to support a first portion of the wide-mouth preform, and a second rail proximate the first rail, where the second rail further comprises a body that defines a cavity. The cavity is configured to receive a second portion of the wide-mouth preform. The cavity has an inner surface configured to prevent jamming of the wide-mouth preform as the preform is transferred along the gravity rail.

### CROSS REFERENCE TO RELATED APPLICATION

This application claims the benefit of priority to U.S. Provisional Patent Application No. 63/404,390, filed Sep. 7, 2022, the contents and disclosure of which are incorporated by reference herein in their entirety.

### TECHNICAL FIELD

The present disclosure relates generally to a gravity transfer rail for blow molding systems, and more particularly gravity transfer rail system for wide-mouth preforms.

### BACKGROUND

Plastic hollow containers are manufactured by blow molding or injection molding systems. In such systems, preforms are fed through various system components such as hoppers, sorters, scramblers, star wheels, blowers, reheat stretch blow molders, heaters and coolers, and the like. The preforms are transferred between system components using a combination of conveyors and rail systems. Such rail systems include gravity rails which may connect an outfeed of a first system component with an infeed of a downstream second system component. The output feed of the first system component is at a higher elevation relative to the infeed feed of a second system component such that the preforms slide along the connecting rail from the first machine to the second machine, drawn along the downward trajectory defined by the rail primarily by gravity.

Preforms conventionally slide along inner flanges of the gravity rail system and are supported by the inner flanges of the rail system along a preform neck. The preform neck is in contact with the rails and this contact enables the preform to slidably follow the rail between system components. Wide-mouth preforms (such as preforms having a diameter of 2 inches (5.1 cm) to 5 inches (12.7 cm)) are more prone to jamming or blocking the rail than standard-mouth preforms. The tendency of wide-mouth preforms to jam or block the rail is a result of the higher center of gravity of the wide-mouth preform in comparison to standard mouth preforms, or due to ovalization of the lip or neck of the wide-mouth preform. The higher center of gravity of the wide-mouth containers urges the containers out of slidable contact with the inner flanges. A jammed wide-mouth preform essentially falls out of the track formed by the inner flanges such that the neck creates a friction fit with at least one inner flange so that the neck is no longer able to slidably travel along the inner flange toward the second system component input feed.

Conventional solutions to the jamming and blocking of rails include creating tighter tolerances between the inner flanges of the rail and the neck of the wide-mouth preform, however the tighter tolerances increase friction between the inner flanges of the rail and the neck of the wide-mouth preform. The greater magnitude friction can negatively impact the integrity of the preform and ultimately result in a lower quality manufactured bottle.

Additionally, when system jamming or blocking occurs, portions or the entirety of the manufacturing line must be shut down to remove the preform that is jammed and causing the rail blockage. Thus, there is a need in the art to mitigate jamming and blocking of wide-mouth preforms in gravity feed rail systems.

### SUMMARY

In one aspect, a gravity rail system is disclosed for transferring wide-mouth preforms. The gravity rail system includes a rail comprising a rail body and pair of ledges positioned a distance from the gravity rail body, the pair of ledges having an opening diameter defined by sidewalls of the ledges. The ledges have a top surface configured to interface with a lip of a wide-mouth preform. A support rail including a U-shaped elongate body and a plastic insert disposed within a cavity formed by the U-shaped elongate body, the plastic insert having an inner surface configured to prevent jamming of the wide-mouth preform in the gravity rail.

In another aspect, a gravity rail system for transferring wide-mouth preforms is disclosed where the gravity rail system comprises a first rail having a pair of opposed ledges. The ledges are spaced apart to define an opening diameter. The ledges have a top surface configured to contact the wide-mouth preform at one end of a wide-mouth preform, and thereby support the wide-mouth preform as the preform moves along the upper rail. The gravity rail system also comprises a second rail proximate the first rail, where the second rail comprises a body that defines a cavity. The cavity is configured to receive a portion of the wide-mouth preform opposite the end that is supported by the ledges. The cavity has an inner surface configured to prevent jamming of the wide-mouth preform as the preform is transferred along the gravity rail.

In another aspect, a gravity rail system for transferring wide-mouth preforms is disclosed. The gravity rail system comprises a first rail configured to support a first portion of the wide-mouth preform, and a second rail proximate the first rail, where the second rail comprises a body that defines a cavity. The cavity is configured to receive a second portion of the wide-mouth preform. The cavity has an inner surface configured to prevent jamming of the wide-mouth preform as the preform is transferred along the gravity rail.

In another aspect a method for transferring a wide-mouth preform along a gravity rail system is disclosed. The gravity rail system for transferring the preform has a first rail and a second rail, where the second rail has a second rail body that defines a cavity having a cavity wall and the method comprises locating a first portion of the wide-mouth preform along the first rail for support by the first rail, disposing a second portion of the preform in the cavity proximate the cavity wall to prevent jamming of the wide-mouth preform, and enabling the preform to move along the first rail.

### BRIEF DESCRIPTION OF THE DRAWINGS

The subject-matter of the disclosure will be explained in more detail in the following text with reference to exemplary embodiments which are illustrated in the attached drawings.

FIG. 1 illustrates a schematic representation of a molding system in accordance with one or more embodiments of the present disclosure;

FIG. 2 illustrates a cross-sectional view of a rail of the molding system of FIG. 1 taken along line B-B;

FIG. 3 illustrates a side view of a wide mouth jar after the wide-mouth preform has been processed and blown into the jar;

FIG. 4 illustrates a cross-sectional view of a rail of the molding system of FIG. 1 taken along line B-B, with the wide-mouth preform jammed within the rail;

FIG. 5 illustrates a cross-sectional view of a support rail of the molding system of FIG. 1 taken along line B-B illustrating the gravity feed rail in accordance with one or more embodiments of the present disclosure; and,

FIG. 6 illustrates a top view of a portion of the support rail of FIG. 5 in accordance with an alternate embodiment of the present disclosure.

The reference symbols used in the drawings, and their meanings, are listed in summary form in the list of reference symbols. In principle, identical parts are provided with the same reference symbols in the figures.

### DETAILED DESCRIPTION

In the following specification and the claims, reference will be made to a number of terms, which shall be defined to have the following meanings.

As used herein, the singular forms “a,” “an,” and “the” include plural references unless the context clearly dictates otherwise. The terms “comprising,” “including,” and “having” are intended to be inclusive and mean that there may be additional elements other than the listed elements. The terms “optional” or “optionally” means that the subsequently described event or circumstance may or may not occur, and that the description includes instances where the event occurs and instances where it does not.

Unless otherwise indicated, approximating language, such as “generally,” “substantially,” and “about,” as used herein indicates that the term so modified may apply to only an approximate degree, as would be recognized by one of ordinary skill in the art, rather than to an absolute or perfect degree. Accordingly, a value modified by a term or terms, such as “about,” “approximately,” and “substantially,” is not to be limited to the precise value specified. In at least some instances, the approximating language may correspond to the precision of an instrument for measuring the value. Here and throughout the specification and claims, range limitations may be identified. Such ranges may be combined and/or interchanged, and include all the sub-ranges contained therein unless context or language indicates otherwise.

Additionally, unless otherwise indicated, the terms “first,” “second,” etc. are used herein merely as labels, and are not intended to impose ordinal, positional, or hierarchical requirements on the items to which these terms refer. Moreover, reference to, for example, a “second” item does not require or preclude the existence of, for example, a “first” or lower-numbered item or a “third” or higher-numbered item.

As used herein, the term “wide-mouth preform” refers to a plastic, thermoplastic or polyethylene terephthalate “PET” plastic preform for use in injection molding and blow molding applications. The preform commonly includes an injection molded body having a threaded end, a lip adjacent to the threaded end, a neck adjacent to the lip, and a cylindrical or conical body adjacent to the neck. Gripping or transfer devices of a manufacturing line for injection molding and blow molding applications commonly interface with the lip and/or the neck of the preform to transfer or secure the preform. A wide-mouth preform is commonly used in forming plastic jars for storing solids, where standard or narrow-mouth preforms are commonly used for storing liquids

Wide-mouth preforms, having a larger diameter and a higher center of gravity relative to standard-mouth preforms, are prone to ovalization and jamming while moving along airveyor transfer rails. The methods, systems, and apparatus described herein overcome at least some disadvantages of wide-mouth preforms. More specifically, the systems apparatus described herein improves the ability to minimize jamming and blocking caused by wide-mouth preforms when the preforms are slidably moving along an airveyor rail.

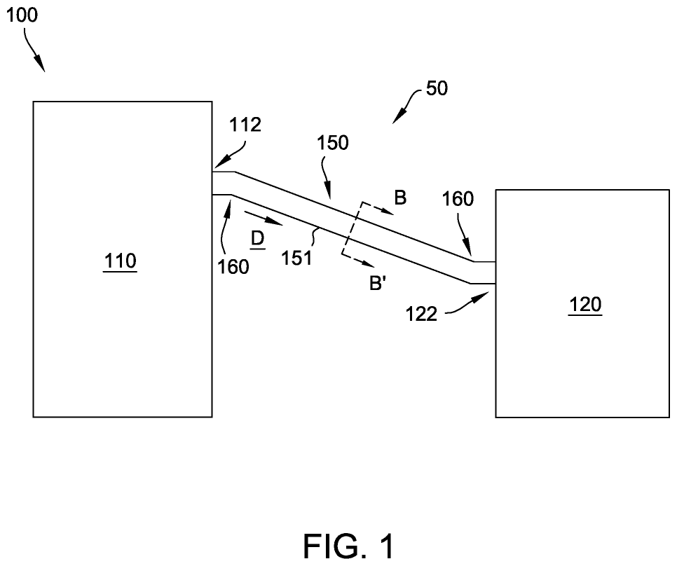

FIG. 1 illustrates a schematic representation of a molding system 100. The molding system 100 includes a first machine 110 and a second machine 120. The first machine 110 and the second machine 120 can be selected from the group consisting of hoppers, sorters, scramblers, star wheels, blowers, reheat stretch blow molders, heaters and coolers, and the like commonly found on manufacturing lines for blow molding. The first machine 110 and second machine 120 process or sort wide-mouth preforms at various stages of the blow molding process. The first machine 110 includes an outfeed 112 for preforms which enables the preforms to move outward from first machine 110. A gravity rail system 50 bridges the distance between the first and second machines. The gravity rail system includes an upper rail 150. The inlet end of the upper rail 150 that connects the outfeed 112 is at a position that is a greater vertical distance above the floor or base than the position of the end of the upper rail 150 where the upper rail connects to the infeed 122 of the second machine 120. As a result, the outfeed 112 of the first machine 110 is at a higher elevation relative to the infeed 122 of the second machine 120. The first machine transfers the preforms to the rail 150 (also referred to as an airveyor). As preforms travel along the rail 150 and downward from the outfeed 112 to the infeed 122, the preforms travel in a downward direction identified as “D” in FIG. 1.

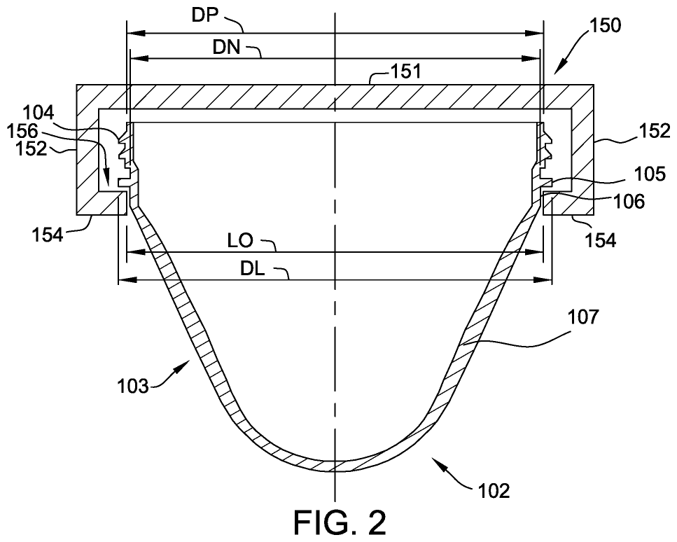

FIG. 2 illustrates a cross-sectional view of the rail 150 and a wide-mouth preform 102. The rail 150 includes an elongate body 151 having a U-shaped channel cross-section with protrusions 152 extending downward from the body 151. The protrusions 152 further include opposed ledges 154 which extend inwardly from the protrusions and are adapted to interface with the wide-mouth preform 102 as explained in further detail below. The opposed ledges 154 define an opening length LO. The gravity rail 150 is illustrated as a U-shaped channel. In other embodiments the rail 150 may have another suitable channel chape. Also, the gravity rail 150 in some embodiments can be a rail assembly having a plurality of rails, where each rail corresponds to at least the body 151 and the ledges 154. In the present disclosure, the rail 150 includes a unitary body 151 and a pair of ledges 154 as shown in FIG. 2.

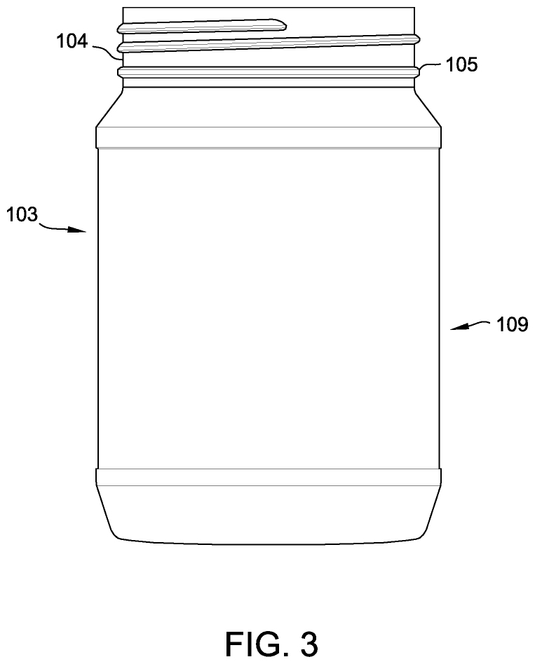

As shown in FIG. 2, the wide-mouth preform 102 includes an injection molded body 103 having a threaded end 104, a circumferentially extending lip 105 adjacent to the threaded end 104, a neck 106 adjacent to the lip 105, and a cylindrical or conical wall 107 adjacent to the neck 106. The threaded end 104 defines a diameter DP of the wide-mouth preform 102. The lip 105 defines a diameter DL of the wide-mouth preform 102. The neck 106 defines a diameter DN of the wide-mouth preform 102. The diameter DN of the neck 106 is in the range of 75%-90% of the diameter DL defined by the lip 105, As explained in further detail below, the neck 106 is prone to ovalization and jamming within the rail 150. As shown in FIG. 3, the wall 107 is blow-molded to form ajar 109 shown in FIG. 3.

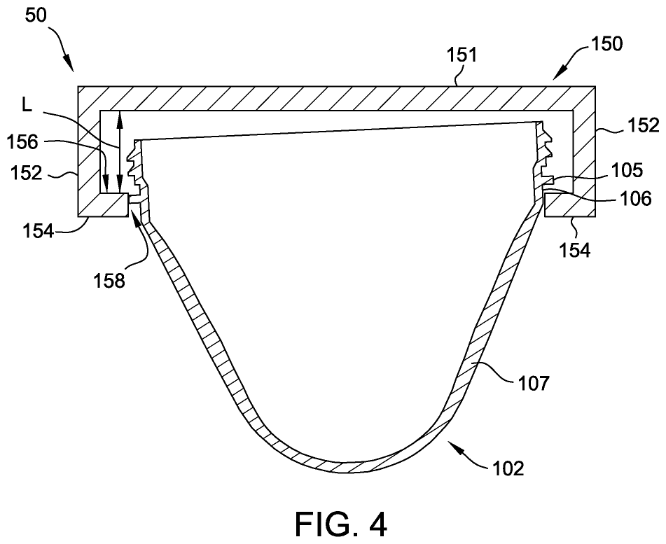

As illustrated in FIG. 2, the magnitude of the ledge opening length, LO defined between the opposed ledges 154 of the rail 150 is less than the magnitude of the lip diameter, DL defined by the circumferentially-extending lip 105. Because the magnitude of dimension DL is greater than the magnitude of the opening LO, when the preform 102 is travelling along the rail 150, the lip 105 is seated on the top surface 156 of the ledges. The lip slides along the top surface as the preform moves in direction D along the rail 150. The magnitude of the opening dimension, LO is greater than the magnitude of the diameter DN of the neck 106 such that the neck 106 is freely movable between the ledges 154. The gap between the free ends of the ledges 154 and the neck 106 is shown in FIG. 2. The magnitude of the neck diameter DN is in the range of 75%-90% of the magnitude of lip diameter DL. Due to relatively loose tolerances between the ledge opening LO and the neck diameter DN, and the ovalization of the wide-mouth preform 102, during movement of the preform along the rail 150 slippage can occur between the preform and rail 150. When such slippage occurs, the lip 105 contacts sidewalls 158 of the ledges 154, creating a jam along the rail 150. See FIG. 4. When the jam occurs, production is shut down or slowed until the jam can be cleared.

Possible approaches to minimizing the likelihood of a jam include creating a tighter tolerance between the ledge opening length LO and the neck diameter DN. However, modifying the dimensions to decrease the distance separating the preform and ledge would increase the likelihood that the ledges and preform would come in non-jam producing frictional contact. The frictional contact would cause the preform 102 to increase in temperature, making the preform 102 malleable. The change in shape produced by the preform malleability may lead to yet further jams along the rail 150. An alternative solution is to decrease the length L between the top surface 156 of the ledges 154 and the elongate body 151, however this solution can produce jams at the locations where the elongate body 151 connects to the outfeed 112 and infeed 122. In particular, as shown in FIG. 1, the rail 150 includes bends 160 proximate the outfeed 112 and infeed 122 such that the wide-mouth preform 102 transitions from an upright orientation supported by protrusions 152 to an orientation parallel to the direction D shown in FIG. 1. Thus, in the embodiment where the wide-mouth preform 102 transitions orientations, a suitable magnitude length L is required in order for the preform to successfully transition orientations without forming a jam. As a result, decreasing the length L is not an option for decreasing jams.

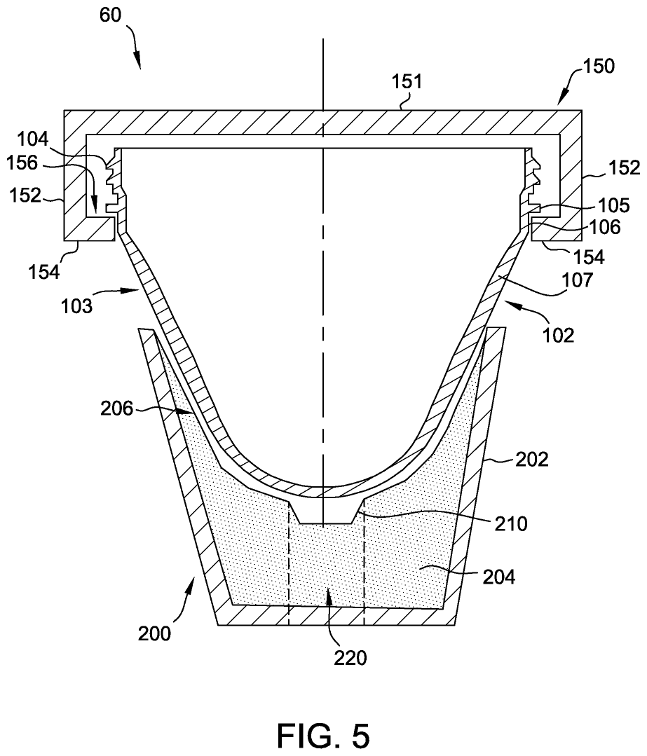

A gravity rail system 60 for transferring wide-mouth preforms is shown in FIG. 5. As shown in FIG. 5, the gravity rail system 60 includes the upper rail 150 previously described in use with system 50, and gravity rail 60 further comprises an additional support rail 200 positioned adjacent the rail 150. In use, the rail 150 supports the upper portion of the preform 102 as the preform moves along the rail 150. The support rail 200 is located adjacent the wall 107 of the preform body 103. The support rail 200 specifically minimizes movement of the body 103 and preform 102 generally to thereby prevent jamming of the wide-mouth preform 102 as the wide-mouth preform 102 travels along the gravity rail 150. The support rail 200 is located below the gravity rail 150. The gravity rail 150 may be referred to as the upper rail and the support rail 200 may be referred to as the lower rail. The gravity rail 150 may also be referred to as a first rail and the support rail 200 may be referred to as a second rail. The support rail 200 is substantially parallel to the length of gravity rail 150 between discrete bends 160 near outfeed 112 and infeed 122.

The support rail 200 includes a U-shaped elongate body 202 and an insert 204 disposed within a cavity 204 formed by the U-shaped elongate body 202. In some embodiments, the insert 204 may be made from a variety of materials, including, but not limited to, ultra-high molecular weight polyethylene (UHMW), high density polyethylene (HDPE), polyoxymethylene (POM or Delrin) or a polytetrafluoroethylene (PTFE) plastic. Additionally, a coating comprising diamond-like carbon (DLC), or Titanium Nitride may be applied to the rail to further reduce the effects of friction on the preform as it travels along the rail. In occurrences where the conical wall 107 of the wide-mouth preform 102 contacts the insert 204, friction is minimized. In some embodiments, the rigidity of the U-shaped elongate body 202 is enhanced by a material such as stainless steel, that is integrated with the insert 204. In some embodiments, an inner surface 206 of the insert 204 is formed to approximate the shape of the conical body 107 of the wide-mouth preform 102, and the inner surface 206 is located closely adjacent, but not normally contacting the conical body 107. The inner surface 206 of the insert 204 is generally positioned a distance from the wide-mouth preform 102 such that the inner surface 206 only contacts the wide-mouth preform 102 when the preform is urged toward an orientation that would produce jamming in prior gravity rail structures. The support rail 200 prevents jamming of the wide-mouth preform in the gravity rail 150, by preventing the preform from reorienting to an undesirable orientation that would produce jamming. In some embodiments, the insert 204 further includes a relief channel 210 extending from the bottom of the inner surface 206 of the insert 204. The relief channel extends longitudinally along the length of the rail 200.

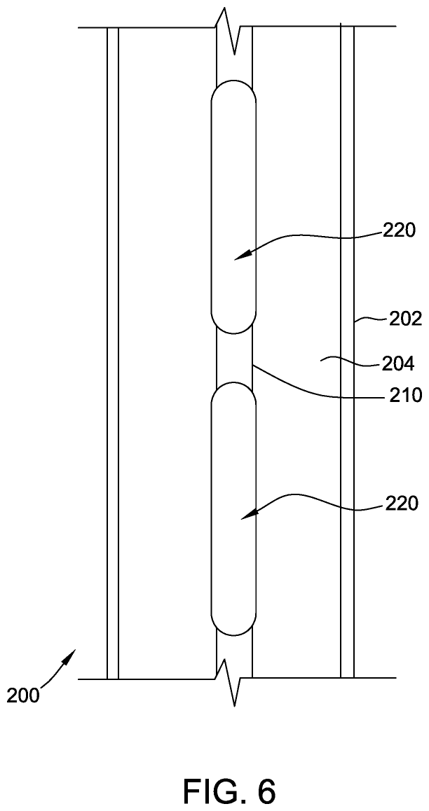

As shown in FIGS. 5 and 6, in some embodiments, a plurality of slots 220 are disposed longitudinally along and extending through the insert 204 and the elongate body 202. Adjacent slots are spaced apart along body 202. The plurality of slots 220 extend through the insert 204 and the elongate body 202 such that wide-mouth preforms 102 are viewable through the plurality of slots 220. The plurality of slots 220 are configured to allow for improved set-up and adjustability of the support rail 200, as well as improved user safety as the plurality of slots 220 allow for the user to view the wide-mouth preforms 102. Although the support rail 200 including the plurality of slots 220 is the preferred embodiment, if required, the support rail 200 may be provided that does not include the plurality of slots 220.

The support rail 200 may be directly attached to the rail 150 using conventional attachment methods including a combination of fasteners and discrete connection members such as plates or brackets for example. The connection members extend between, and are attached to, both the rail 150 and the support rail 200. The discrete connection members may be fastened to the rail 150 at the protrusions 152 and to the support rail 200 along the support rail body 202.

In addition to the fasteners and discrete connection members, or in place of the fasteners and discrete members, support members (not shown) such as elongate support rods or legs may be provided to maintain the support rail 220 for use in a position proximate the rail 150. When used, the lower end of each used support member is fixed to a floor, or other support surface located below the rail 150 and support rail 220. Each support member extends from its fixed position along the support surface and the opposite end of each support member is positioned as required to maintain the support rail 220 proximate rail 150. The support members may be connected directly to the support rail body 202, or to a discrete member that is in turn fixed to the support rail body 202. The support members are free standing.

The methods, systems, and compositions disclosed herein are not limited to the specific embodiments described herein, but rather, steps of the methods, elements of the systems, and/or elements of the compositions may be utilized independently and separately from other steps and/or elements described herein. For example, the methods, systems, and compositions are not limited to practice with only a rotary machine as described herein. Rather, the methods, systems, and compositions may be implemented and utilized in connection with many other applications.

Although specific features of various embodiments may be shown in some drawings and not in others, this is for convenience only. Moreover, references to “one embodiment” in the above description are not intended to be interpreted as excluding the existence of additional embodiments that also incorporate the recited features. In accordance with the principles of the disclosure, any feature of a drawing may be referenced and/or claimed in combination with any feature of any other drawing.

This written description uses examples, including the best mode, to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A gravity rail system for transferring wide-mouth preforms, the gravity rail comprising:
a first rail having a pair of opposed ledges, the ledges spaced apart to define an opening diameter, the ledges having a top surface configured to contact the wide-mouth preform at one end of a wide-mouth preform, and thereby support the wide-mouth preform as the preform moves along the upper rail and,
a second rail proximate the first rail, the second rail comprising a body that defines a cavity, the cavity configured to receive a portion of the wide-mouth preform opposite the end that is supported by the ledges, the cavity having an inner surface configured to prevent jamming of the wide-mouth preform as the preform is transferred along the gravity rail.

2. The gravity rail system of claim 1 wherein the first rail is located above the second rail.

3. The gravity rail system of claim 1 wherein the second rail further comprises an insert disposed in the cavity.

4. The gravity rail system of claim 1 wherein the second rail has a U-shaped configuration.

5. The gravity rail system of claim 2 wherein the insert is made from a material in the group consisting of ultra-high molecular weight polyethylene (UHMW), high density polyethylene (HDPE), polyoxymethylene (POM or Delrin) or a polytetrafluoroethylene (PTFE) plastic.

6. The gravity rail system of claim 5 wherein the insert includes a coating comprising diamond-like carbon (DLC) or Titanium Nitride.

7. The gravity rail system of claim 3 wherein the insert includes a relief channel along the bottom of the insert.

8. The gravity rail system of claim 7 wherein the relief channel extends along the length of the second rail.

9. The gravity rail system of claim 1 wherein the second body includes at least one slot disposed along the second rail, the at least one slot extending through the second rail.

10. The gravity rail system of claim 9 wherein the second rail includes a plurality of slots.

11. The gravity rail system of claim 1 wherein the second rail further comprises an insert member located in the second rail cavity, and wherein the second rail includes a plurality of spaced apart slots extending through the insert member and second rail body.

12. A gravity rail system for transferring wide-mouth preforms, the gravity rail system comprising:
a first rail configured to support a first portion of the wide-mouth preform, and
a second rail proximate the first rail, the second rail comprising a body that defines a cavity, the cavity configured to receive a second portion of the wide-mouth preform, the cavity having an inner surface configured to prevent jamming of the wide-mouth preform as the preform is transferred along the gravity rail.

13. The gravity rail system of claim 12 wherein the first rail supports the upper portion of the preform, and the cavity receives the lower portion of the preform.

14. The gravity rail system of claim 12 wherein the second rail further comprises an insert disposed in the cavity.

15. The gravity rail system of claim 12 wherein the second rail has a U-shaped configuration.

16. The gravity rail system of claim 13 wherein the second rail includes a plurality of slots extending through the insert and second rail body.

17. A method for transferring a wide-mouth preform along a gravity rail system where the gravity rail system has a first rail and a second rail, the second rail having a second rail body that defines a cavity having a cavity wall, the method comprising locating a first portion of the wide-mouth preform along the first rail for support by the first rail, disposing a second portion of the preform in the cavity proximate the cavity wall to prevent jamming of the wide-mouth preform, and enabling the preform to move along the first rail.
